(19) United States
(12) Patent Application Publication
(10) Pub. No.: US 2007/0266994 A1
(43) Pub. Date: Nov. 22, 2007

(54) Hydraulically Driven Pump-Injector for Internal Compustion Engines with Hydromechanical Return Device of the Power Piston

(75) Inventor: Boris Feinleib, Jerusalem (IL)

Correspondence Address: NATH & ASSOCIATES, 112 South West Street, Alexandria, VA, 22314, US

(73) Assignee: MAZREK Ltd., Jerusalem (IL)

(21) Appl. No.: 11/578,727

(22) PCT Filed: Jan. 25, 2004
(86) PCT No.: PCT/IL04/00070

§ 371 Date: Feb. 2, 2007

(51) Int. Cl. F02M 59/02

(52) U.S. Cl. 123/445

(57) ABSTRACT

Hydraulically driven pump-injector for internal combustion engines with hydromechanical return of the power piston (1) via an auxiliary cavity (13).

### TECHNICAL FIELD

Present invention relates to the field of fuel supply systems for internal combustion engines, in particular to diesels and their fuel pump-injectors, primarily to those having hydraulic drive of the power piston with pumping plunger for intensifying the injection pressure.

### BACKGROUND ART

Conventional hydraulically driven pump-injectors with pressure intensifiers for diesels comprise: a body with inlet and outlet channels for the connection with a source of actuating fluid (accumulator or rail), which in turn is connected to the actuating fluid pump, and a drain tank or sump, respectively; pressure intensifier, comprising a power piston and a pumping plunger, a working cavity being formed above the said power piston in the pump-injector body, into which the actuating fluid is introduced that drives the power piston and pumping plunger, and a drain cavity connected to the drain tank or sump being formed under the piston; distributing device with a valve, predominantly having an electromagnetic drive controlled by electronic unit (the valve can also be controlled by piezoelectric, magnetostriction, mechanical or other devices), mounted in the body of the pump-injector between said inlet and outlet channels and the power cavity above the power piston; sprayer unit; and a spring (spring mechanism) that returns said power piston with pumping plunger into the starting position after the end of the working stroke of the power piston with plunger and thus enables reciprocal motion of the parts of the intensifier mechanism. Return spring is also used in conventional designs of pump-injectors with the plunger driven by cam mechanism via pushrod. In known pump-injectors, a cylindrical spiral spring is normally used in the return mechanism. In this case, spring return mechanism, especially in pump-injectors with hydraulic drive of the pumping plunger, usually has big dimensions (length) in order to ensure the required force in the beginning and at the end of the return stroke of the power piston with pumping plunger, as confirmed by calculations on p. 9 below. Increasing the length of the spring, and accordingly, of the pump-injector, interferes with mounting the pump-injector in the engine cylinder head. This drawback is especially significant when designing pump-injectors with hydraulic drives for diesels with high rotational speeds of crankshaft since the time for return stroke of the power piston with pumping plunger decreases, as well as for high-power diesels having multiple injections capability (for instance, for locomotives, heavy off roads and marine applications).

### DISCLOSURE OF INVENTION

The present invention is aimed at replacing the spring return mechanism of the power piston with pumping plunger with a hydromechanical return device which allows for obtaining the force needed for return stroke of the power piston with plunger in diesels with high rotational speeds of crankshaft and multiple injection capability. At the same time, the proposed hydromechanical return device has small dimensions allowing for a considerable decrease in the dimensions of the pump-injector, and for mounting it in cylinder heads of the existing diesels. As already mentioned, the proposed hydromechanical return device is especially efficient in hydraulically driven pump-injectors. In such pump-injectors, high strokes of the pumping plunger are normally realized with relatively small pumping plunger diameters, required for implementing high levels of pressure multiplication (up to 9). This is needed for high-power diesels with multiple injection capability and high injection pressures (up to 2000 Bar and higher), and relatively low pressures of the actuating fluid (up to 200 Bar). This issue is considered in detail in p. 10 below. Therefore, further description of this invention is given with regard to systems with hydraulically driven pump-injectors which are considered as preferential application of the proposed hydromechanical return device of power piston and pumping plunger.

Hydraulically driven pump-injector with hydromechanical return device of the power piston comprises: a body with inlet and outlet channels for the connection with a source of actuating fluid/accumulator (which is in turn connected to the actuating fluid pump), and a drain tank or sump, respectively, said body having coaxial cylindrical cavities of different diameters, the cavity of a larger diameter being divided by a partition into two cavities, the main cavity and the auxiliary working cavity; a pressure intensifier, disposed in said cylindrical cavities of the pump-injector body, comprising a power piston moving in said main cylindrical cavity of a larger diameter disposed above the partition, a working cavity being formed above the piston, and a drain cavity being disposed under the piston, and a pumping plunger, moving in the internal cylindrical cavity of a smaller diameter of the pump-injector body; a distributing device with a valve preferably having an electromagnetic drive controlled by electronic unit (the valve can also be controlled by piezoelectric, magnetostriction, mechanical or other devices), installed in the pump-injector body between inlet and outlet channels and the working cavity above the power piston, periodically connecting the working cavity above the power piston with the said channels; and a sprayer unit.

In this configuration of hydromechanical return device, in order to implement the return stroke of the power piston with pumping plunger, said auxiliary working cavity formed between said partition in the pump-injector body and the cavity of a smaller diameter in which the plunger is moving, is constantly connected with the source of the actuating fluid (accumulator or rail), and the plunger is made stepped, so that the larger diameter part of the plunger whose one end contacts the piston moves in the aperture made coaxially with the plunger in said partition, the smaller diameter (pumping) part of the plunger moves in said cylindrical cavity of a smaller diameter in the pump-injector body, and the second face of said larger diameter part of the plunger contacts actuating fluid disposed in said auxiliary cavity.

In the proposed hydromechanical return mechanism of the power piston with pumping plunger, the force that returns the piston with the plunger into the starting position (the extreme upper position) after the completion of the working stroke, is formed due to the action of the pressure of the actuating fluid on the surface which equals the difference between the cross-sectional areas of the larger diameter and smaller diameter parts of the plunger. The return force may thus be increased as much as needed by increasing the difference between the diameters of the larger diameter and smaller diameter parts of the plunger.

### SUMMARY OF THE INVENTION

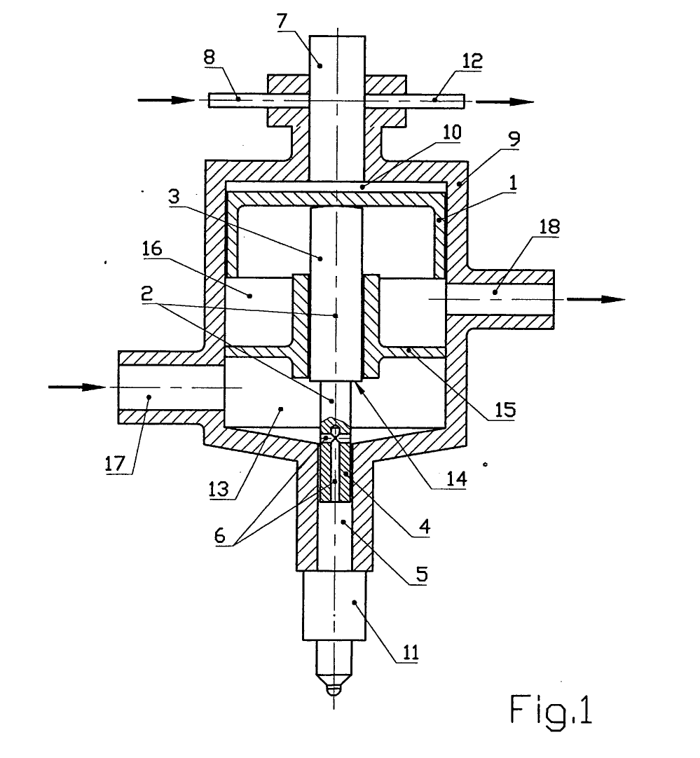

Functional diagram of the pump-injector with hydromechanical return device of the power piston with pumping plunger is shown in FIG. 1, where 1—power piston; 2—pumping plunger, 3—larger diameter part of the plunger, 4—smaller diameter (pumping) part of the plunger, 5—under-plunger cavity, 6—filling channels in he plunger, 7—distributing device, 8—channel in the pump-injector body for supplying the actuating fluid to the distributing device, 9—pump-injector body, 10—working cavity above piston; 11—sprayer unit; 12—channel in the pump-injector body for removing the exhausted actuating fluid from above-piston cavity to the drain tank or sump, 13—auxiliary working cavity formed in the pump-injector body, 14—annular surface of the larger diameter part of the plunger subject to the pressure of the actuating fluid in cavity 13, 15—partition, confining auxiliary working cavity 13, 16—drain cavity under power piston, 17—channel, through which actuating fluid is supplied to the auxiliary working cavity, 18—channel through which drain cavity under the piston is connected with the drain tank or sump.

Pump-injector with the proposed hydromechanical return mechanism of the power piston 1 with plunger 2 operates in the following way (see FIG. 1). When piston 1 with plunger 2, having larger diameter part 3, adjacent to the piston, and smaller diameter (pumping) part 4, is in the extreme upper position under effect of force from pressure of actuating fluid on annular end 14 of larger diameter part 3 of plunger 2, under-plunger cavity 5 is filled with fuel (or actuating fluid if fuel is used as the latter) through channels 6 in plunger 2. When the electromagnet of the valve of distributing device 7 is energized by the electronic control unit, actuating fluid through inlet channel 8 in the body of pump-injector 9 is introduced through distributing device 7 into above-piston working cavity 10. Under the pressure of the actuating fluid, power piston 1 with plunger 2 moves to the extreme lower position, and pumping part 4 of plunger 2 after closing filling channels 6 expels the fuel through sprayer unit 11 into the diesel cylinder. When the electromagnet of the valve of distributing device 7 is de-energized, actuating fluid ceases to enter from distributing device 7 to above-piston working cavity 10, and working cavity 10 communicates to the drain tank or sump through distributing device 7 and outlet channel 12 in the body of pump-injector 9. The pressure in above-piston cavity 10 falls, and power piston 1 with plunger 2 returns to the initial (extreme upper) position moved by the pressure of actuating fluid in auxiliary working cavity 13 on annular surface 14 of the larger diameter part 3 of plunger 2. To ensure normal functioning of hydromechanical return device, diameter of pumping part 4 of plunger 2 must be smaller than that of the larger diameter part 3, and the latter's diameter must be smaller than that of power piston 1.

In proposed pump-injector, change in the cyclic fuel delivery is achieved by changing the value of the working stroke of piston 1 with plunger 2 by changing the duration of the electric signal fed from the electronic control unit to the electromagnet of the valve of distributing device 7.

It will be appreciated that foregoing specification and drawing are set forth by the way of illustration and not limitation and that various modifications and changes maybe made without departing from the spirit and scope of present invention.

### BEST MODE FOR CARRYING OUT OF THE INVENTION

The proposed hydromechanical return mechanism of the piston with plunger is best implemented in hydraulically driven pump-injectors, in which fuel is used as actuating fluid for driving piston and plunger and is injected into the combustion chamber. In this case, auxiliary working cavity 13 (in which actuating fluid is disposed), contacting annular surface 14 of the larger diameter part 3 of plunger 2 can be used as a capacity from which the under-plunger cavity is filled with fuel through channel 6. This simplifies the design of the pump-injector and increases its reliability. However, the proposed hydromechanical return mechanism of power piston with plunger can be implemented in hydraulically driven pump-injector, in which oil is used as actuating fluid for driving piston with plunger. In this case the design of pump-injector becomes more complicated, and reliability decreases, because an additional cavity containing oil will have to be separated from fuel cavities and channels of pump-injector by means of rubber or other seals.

In the proposed invention, larger diameter part 3 of plunger 2 moves in the aperture of partition 15, formed in the body of pump-injector 9. In order to decrease the fuel flow-over, the larger diameter part 3 of plunger 2 must be tightly mounted in the aperture of partition 15 by precision connection of said components, or by installing a sealing device between larger diameter part 3 of plunger 2 and the aperture of partition 15. In hydromechanical return device of piston with plunger in accordance with the invention, larger diameter part 3 of plunger 2 can be manufactured as a single piece with the pumping part 4, as shown in FIG. 1. However, they can also be manufactured as separate parts that are connected to each other by a hinge joint, for instance, a fork and pivot journal, mounted respectively on said parts.

### INDUSTRIAL APPLICABILITY

The preferred application of the proposed hydromechanical return mechanism of power piston with plunger is for pump-injector with hydraulic drive of the pumping plunger from power piston. However, the proposed hydromechanical return mechanism can also be used in pump-injector with plunger driven by a cam. In this case, larger diameter part of plunger is used as a pushrod transferring the motion from cam to the pumping part of the plunger, and an autonomous source of actuating fluid is used for filling the auxiliary working cavity, with the pressure required for ensuring the return stroke of the pushrod with plunger.

As mentioned above, the proposed hydromechanical return device of power piston is especially efficient when it replaces conventional spring mechanism in high-power diesels. Let us consider this problem with regard to a standard locomotive diesel in which cyclic delivery may reach V_{C}=2.5 cm³.

Mounting length, l of the spring of the return mechanism can be obtained from the following expression:
l=1.2di+h, cm (1),
where d—diameter of the spring wire, 1.2—coefficient for the distance between the spring coils when compressed; i—number of coils; h—travel of piston with plunger.

Diameter of the opening for installing pump-injector in the cylinder head of the diesel, taken as an example, can amount to approximately 5 cm. Considering the thickness of the walls of the pump-injector body required for disposing the channels for introducing the fuel into under-plunger space, the diameter of the power piston cannot exceed 3.3 cm. Since the return spring is normally located in the piston skirt in order to reduce the length of the pump-injector, the external diameter of the spring cannot exceed 3 cm considering the thickness of the piston skirt walls.

If we assume that the ratio of the average diameter of the spring (D) to wire diameter (d) is 5 (which is the most common ratio for state-of-the-art production conditions and for ensuring longitudinal spring stability), we'll obtain the maximum possible values for average spring diameter, D which in our example equals approximately 2.5 cm, and the wire diameter, d which equals 0.5 cm.

As already mentioned, in modern diesels, and especially in high-power ones, the injection pressure must be at least 2000 Bar to ensure high fuel efficiency and acceptable exhaust emission levels. At such values of injection pressure and relatively low values of the actuating fluid pressure (up to 200 Bar), selected for increased reliability of the system, the coefficient of pressures multiplication must be at least 10-11. In this case (based on the value of the piston diameter calculated above, i.e. 3.3 cm), diameter of plunger must equal approximately 0.9-1 cm, and the plunger travel h based on the assumed value of V_{C}=2.5 cm³ must equal approximately 3 cm. Using known correlation for maximum allowed force of the spring P_{SP}^{max}
P_{SP}^{max}=τπd³/8D, kgf (2),
where τ is maximum allowed tension of torsion, and for spring rate, k
k=Gd⁴/8D³i, kgf/cm (3),
where G is modulus of shear by torsion, and taking into account that
P_{SP}^{ma}=P_{SPi}+kh, cm (4),
where P_{SPi}—spring mounting force, we can obtain the required number of coils, i.

In this calculation, we assume P_{SPi}=10 kgf (to meet the requirement of guaranteed expulsion of actuating fluid from above-piston cavity during the return stroke of power piston with plunger).

According to (2), based on the above values of D=2.5 cm and d=0.5 cm, and assuming that maximum allowable tension of torsion, rat cyclic load is τ=3000 kgf/cm², we'll obtain the maximum allowable spring power of 58 kgf. According to (4) and based on P_{SP}^{m}=58 kgf, and P_{Spi}=10 kgf, we'll obtain the following value for kh: kh=58−10=48 kgf. Since based on the above, h must be 3 cm, we'll obtain the desired value for spring rate k=48:3=16 kgf/cm.

According to (3), the number of coils required to ensure the obtained value of the spring rate k=16 kgf/cm is approximately 25, and according to (1), the mounting length of the spring will equal approximately 18 cm. A spring of such length will not have longitudinal stability and cannot be used in a real pump-injector and engine cylinder head due to dimensioning considerations.

The fact that such a large return spring is required makes the use of hydraulically driven pump-injectors in large high-power Diesel engines (mainly used for industrial applications) impractical. The proposed invention allows for a compact design, which makes it possible to use such pump-injectors not only in OEM, but as retrofit injection systems as well.

I claim:

1. Hydraulically driven pump-injector with return hydromechanical device of the piston for internal combustion engines, specifically for diesels, comprising: a body with inlet and outlet channels for the connection with a source of actuating fluid/accumulator (which is in turn connected to the actuating fluid pump), and a drain tank or sump, respectively, said body having coaxial cylindrical cavities of different diameters, the cavity of a larger diameter being divided by a partition into two cavities, the main cavity and the auxiliary working cavity; a pressure intensifier, disposed in said cylindrical cavities of the pump-injector body, comprising a power piston moving in said main cylindrical cavity of a larger diameter disposed above the partition, a working cavity being formed above the piston, and a drain cavity being disposed under the piston, and a pumping plunger moving in the internal cylindrical cavity of a smaller diameter of the pump-injector body; a distributing device with a valve preferably having an electromagnetic drive controlled by electronic unit (the valve can also be controlled by piezoelectric, magnetostriction, mechanical or other devices ), installed in the pump-injector body between inlet and outlet channels and the working cavity above the piston, and periodically connecting the above-piston working cavity with said channels, and a sprayer unit.

2. Hydraulically driven pump-injector as in claim 1, wherein said auxiliary working cavity formed between partition in pump-injector body and cavity of smaller diameter where piston is moving, is constantly connected to the source of actuating fluid (accumulator), and the plunger is stepped, its larger diameter part, whose one end contacts the piston, moving in the aperture made in the said partition coaxially with the plunger, and its smaller diameter (pumping) part moving in the said cylindrical cavity of smaller diameter located in pump-injector body, while the second end of said larger diameter part of plunger contacts actuating fluid located in said auxiliary working cavity.

3. Hydraulically driven pump-injector as in claim 2, wherein diameter of said larger diameter part of plunger is smaller than diameter of power piston, and diameter of smaller diameter part of plunger is smaller than diameter of larger diameter part of plunger.

4. Hydraulically driven pump-injector as in claim 3, wherein the plunger can be made of one piece or composite, consisting of larger diameter and smaller diameter pumping parts, connected by hinge joint.

5. Hydraulically driven pump-injector as in claim 4, wherein hinge joint consists of a fork on the larger diameter part of plunger and pivot journal on the smaller diameter (pumping) part of plunger, or alternatively, pivot journal is on the larger diameter part and fork is on the smaller diameter (pumping) part of plunger.

6. Hydraulically driven pump-injector as in claim 5, wherein larger diameter part of plunger, moving in said aperture in the partition in the pump-injector body, has a tight connection with said aperture in partition achieved by adjusted precision surfaces or by a sealing device (for instance, a rubber sealing device in the partition).

7. Hydraulically driven pump-injector as in claim 6, wherein the pumping part of plunger has filling channels connecting under-plunger cavity with said auxiliary working cavity at the end of plunger return stroke and during the plunger dwell in the extreme upper position.
